(19) United States
(12) Patent Application Publication
(10) Pub. No.: US 2019/0177109 A1
(43) Pub. Date: Jun. 13, 2019

(54) A Stabilising Assembly and a Marking Device

(71) Applicant: Spectrum Technologies Limited, Mid Glamorgan (GB)

(72) Inventor: Christopher Edwin Williams, West Glamorgan (GB)

(21) Appl. No.: 16/328,666

(22) PCT Filed: Aug. 29, 2017
(86) PCT No.: PCT/GB2017/052514

§ 371 Date: Feb. 26, 2019

(30) Foreign Application Priority Data
Aug. 31, 2016 (GB) 1614746.4

(51) Int. Cl. B65H 57/26; B41J 3/407

(52) U.S. Cl. CPC B65H 57/26; B65H 2701/34; B41J 3/407

(57) ABSTRACT

A marking device for marking elongate members, including wires and cables is disclosed, together with a stabilising assembly (10) for stabilising elongate members during a marking thereof. The assembly comprises a stabiliser (10a) comprising a first jaw (11) having at least a first planar portion and a second jaw (12) having at least a second planar portion, the first planar portion being positioned adjacent the second planar portion and arranged in a face-to-face relation therewith. The first and second planar portions are orientated in a substantially parallel orientation to define a linear channel therebetween, along which a member is arranged to pass for marking.

The present invention relates to a stabilising assembly for stabilising elongate members during a marking thereof. The present invention further relates to a marking device for marking elongate members.

Wires and cables of the electrical and optical variety typically comprise an insulating sheath or jacket which surrounds an elongate core. In many applications, including the aerospace industry, it is common to group a number of wires or cables (hereafter referred to as wires) together to form a wire harness, which is surrounded by a jacket and then routed along an aircraft for example, to couple various electronic devices. To ensure that the correct wires are connected to the appropriate terminals of the devices it is common practice to mark or otherwise apply identification indicia on the exterior surface of the harness and each wire associated therewith. The indicia may comprise a simple code, such as an alpha numeric code, and this code is typically applied at preset locations along the length of the wire so that each wire within the harness can be suitably identified and distinguished from other wires in the harness at various locations along the length thereof.

The marking of the wires may be performed using an ink-jet or laser printer for example, which apply the indicia to the wire as the wire is passed under a print head. In the case of laser marking, the mark may be formed by ablating a portion of the sheath or by creating a permanent discolouration in a portion of the sheath, whereas with ink-jet printing the mark is formed by directing a stream of ink droplets onto the outer surface of the wire. However, in both cases the wire is marked while it is in motion, as it passes under the print head in a technique known as marking “on-the-fly”, and given that the wires are typically only a few millimeters in diameter, then fine positional control of the wire is required to ensure that the marking is performed at the correct position on the outer surface of the wire. This is particularly relevant in situations where the features of the mark are created using an array or matrix of dots, whereby each dot is formed by a laser pulse or ink-droplet, for example. It is found that any vibration or misalignment of the wire as it passes the print head can result in a misalignment of the dots which can lead to a blurring of the indicia or even a complete misprint of the indicia.

In an endeavour to minimise the effects of wire movement, wires are typically marked as they are passed in sliding contact over a surface. The contact of the wire with the surface is found to assist in reducing wire movement. However, a problem with this technique is that variations in the cross-sectional shape of the wire along the length thereof manifest as a lateral movement of the wire as it passes over the surface. This is particularly a problem in situations the wire comprises a non-uniform cross-section, such as with twisted multi-conductor cables.

We have now devised a stabilising assembly and a marking device for reducing undesirable movement of elongate members during a marking thereof.

In accordance with a first aspect of the present invention, there is provided a stabilising assembly for stabilising elongate members during a marking thereof, the assembly comprising a stabiliser comprising a first jaw having at least a first planar portion and a second jaw having at least a second planar portion, the first planar portion being positioned adjacent the second planar portion and arranged in a face-to-face relation therewith, the first and second planar portions being orientated in a substantially parallel orientation to define a linear channel therebetween along which a member is arranged to pass for marking.

In an embodiment, at least one of the first or second jaw is moveable relative to the second or first jaw respectively, to vary a separation of the first and second planar portions.

The width of the channel is adjustable so that the planar portions can be brought into contact with the member, which may comprise a wire for example, disposed therebetween. The member is marked within the channel as the member passes along the channel and in this respect, the member is not clamped by the jaws, but rather stabilised to minimise undesirable lateral vibrations thereof. The assembly may be used to stabilise twisted multi-conductor wires and as such, the length of the channel is preferably longer than the length of the period of the twist along the wire.

In an embodiment, the stabilising assembly further comprises at least one actuator for moving at least one of the first or second jaws for varying a separation of the jaws. The assembly further comprises a guide arrangement for maintaining the relative orientation of the first and second jaw as the separation of the jaws is varied. In an embodiment, the guide arrangement comprises a first and second key which are coupled to a respective jaw. The guide arrangement further comprises a keyway and at least a portion of the first and second keys are arranged to slide within the keyway. The keyway may be common to both the first and second keys or alternatively, the portion of each key may be arranged to slide within a respective keyway. However, in either scenario, the location of the keys within the keyway is arranged to preserve the orientation of the jaws as the separation therebetween is varied.

In an embodiment, the first and second keys are coupled to a central portion of the first and second jaw thereof, respectively. The guide arrangement may further comprise stabilising supports for supporting the jaws at each end thereof.

In an embodiment, the stabiliser further comprises an entrance disposed at an upstream end of the channel for receiving the elongate member into the channel and an exit disposed at a downstream end of the channel, via which the member exits the channel. The entrance is defined between a proximal end face of each jaw, which separately comprise a curved surface that extends around an axis orientated substantially transverse to an axis along which the member extends in passing along the channel, such that the proximal end face of each jaw extends from an inner side to an outer side of the stabiliser. The proximal end faces of the jaws thus diverge away from the upstream end of the channel to create an entrance which tapers inwardly toward the channel and thus facilitates the passage of the member into the channel.

The exit of the channel is defined between a distal end face of each jaw, which separately comprise a curved surface that extends around an axis which is similarly orientated substantially transverse to an axis along which the member extends in passing along the channel, such that the distal end face of each jaw extends from an inner side to an outer side of the stabiliser. The distal end faces of the jaws thus diverge away from the downstream end of the channel to create an exit which minimises any snagging of the member as it exits the channel.

In an embodiment, the proximal end face of the first and second jaw separately comprise a radius of curvature which are substantially the same.

In an embodiment, the distal end face of the first and second jaw separately comprise a radius of curvature which are substantially the same.

In an embodiment, the radius of curvature of the proximal end faces is greater than the radius of curvature of the distal end faces.

In an embodiment, the stabiliser comprises a longitudinal opening which extends along the length of the stabiliser, and is defined between cooperating longitudinal side faces of each jaw. The longitudinal side face of each jaw preferably comprises a planar face which extends from an inner side of the stabiliser to an outer side of the stabiliser, along the length of the channel. The longitudinal side face of each jaw preferably diverge with respect to each other, in a direction which is away from the channel. Accordingly, the longitudinal side face of each jaw cooperate to form a tapered opening such that the member can easily locate within the channel via the longitudinal opening, for example.

In an embodiment, the stabilising assembly further comprises a translation mount for suitably positioning the channel relative to the member.

In accordance with a second aspect of the present invention, there is provided a marking device for marking elongate members comprising guide means, drive means and a stabilising assembly of the first aspect, the guide means being arranged to guide an elongate member through the channel of the stabiliser as the member is driven along the channel by the drive means, the marking device further comprising a printing device for marking the member within the channel as the member passes along the channel.

In an embodiment, the printing device comprises a laser printing device. However, in an alternative embodiment the printing device may comprise an ink-jet printing device.

The guide means preferably comprises a guide wheel and the drive means may comprise a drive wheel around which the member is arranged to pass. In an alternative embodiment, the drive means may comprise track arrangement comprising a first and second track which are arranged to grip the member and drive the member through the channel.

Whilst the invention has been described above, it extends to any inventive combination of features set out above or in the following description. Although illustrative embodiments of the invention are described in detail herein with reference to the accompanying drawings, it is to be understood that the invention is not limited to these precise embodiments.

Furthermore, it is contemplated that a particular feature described either individually or as part of an embodiment can be combined with other individually described features, or parts of other embodiments, even if the other features and embodiments make no mention of the particular feature. Thus, the invention extends to such specific combinations not already described.

The invention may be performed in various ways, and by way of example only, embodiments thereof will now be described, reference being made to the accompanying drawings in which:

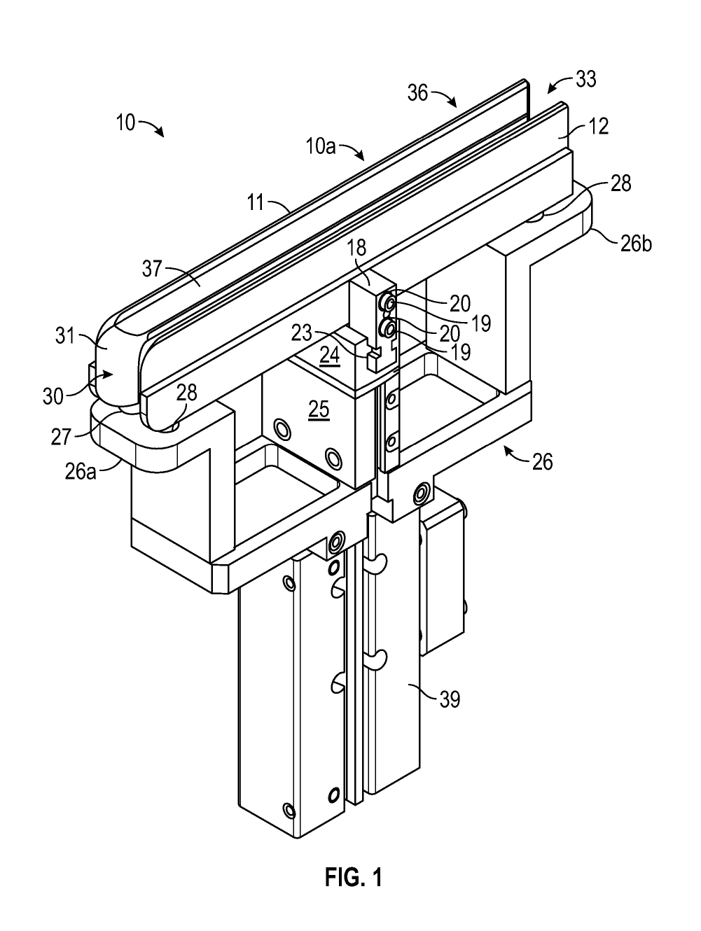

FIG. 1 is a perspective view of a stabilising assembly according to an embodiment of the present invention;

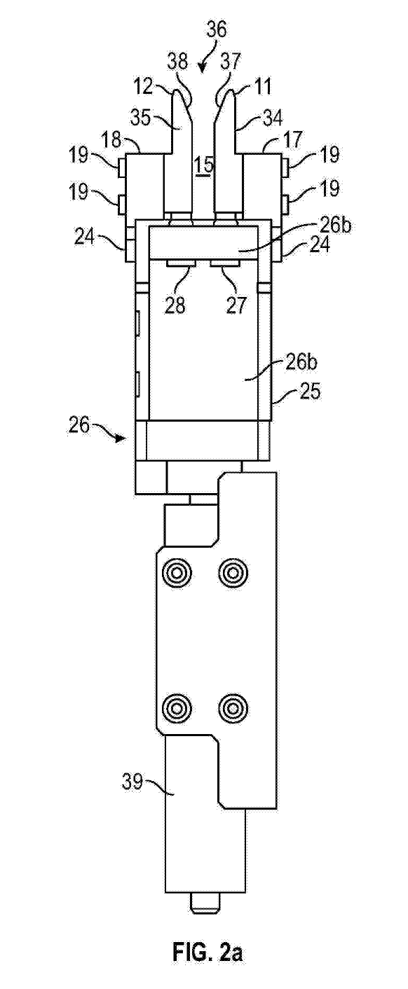

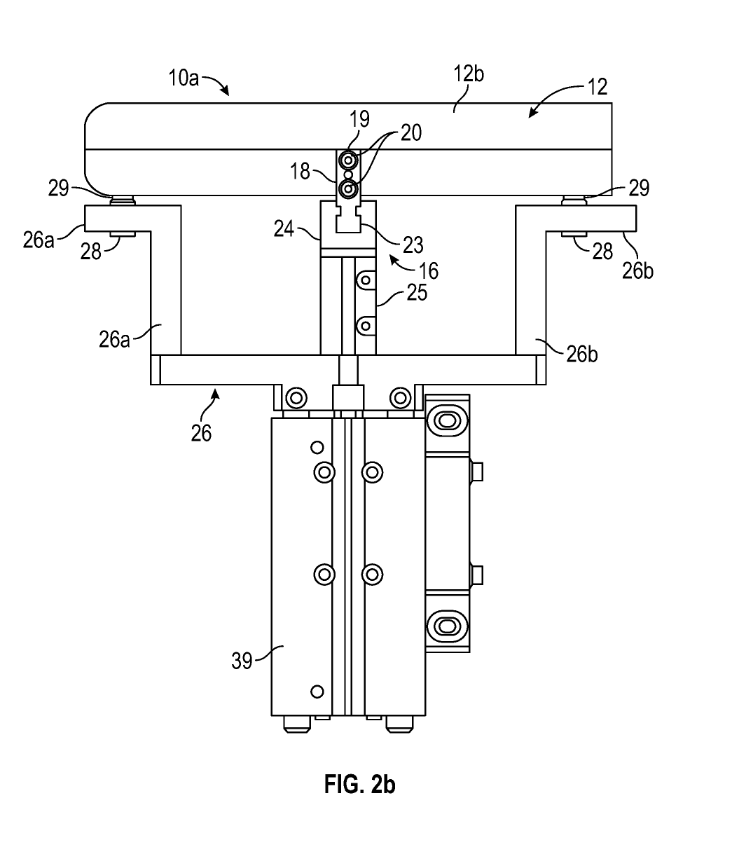

FIG. 2a is a view of the stabilising assembly illustrated in FIG. 1, from the downstream end;

FIG. 2b is a side view of the stabilising assembly illustrated in FIG. 1;

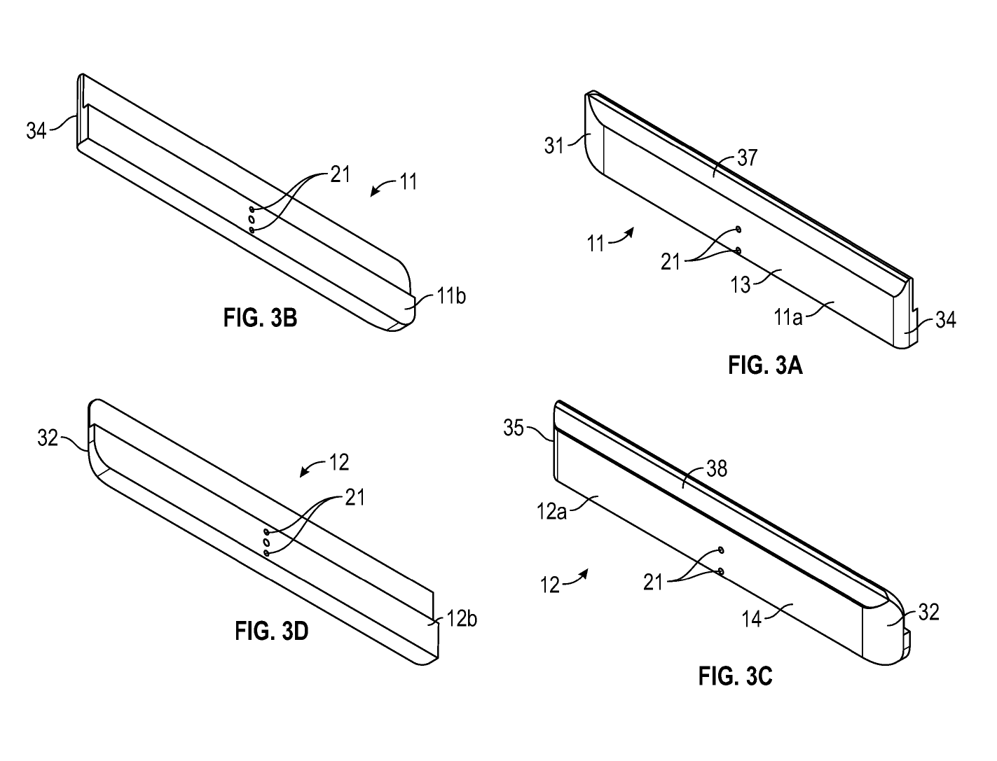

FIG. 3a is a perspective view of the first jaw of the stabilising assembly illustrated in FIG. 1, from an inner side thereof;

FIG. 3b is a perspective view of the jaw illustrated in FIG. 3a, from an outer side thereof;

FIG. 3c is a perspective view of the second jaw of the stabilising assembly illustrated in FIG. 1, from an inner side thereof;

FIG. 3d is a perspective view of the jaw illustrated in FIG. 3c, from an outer side thereof; and,

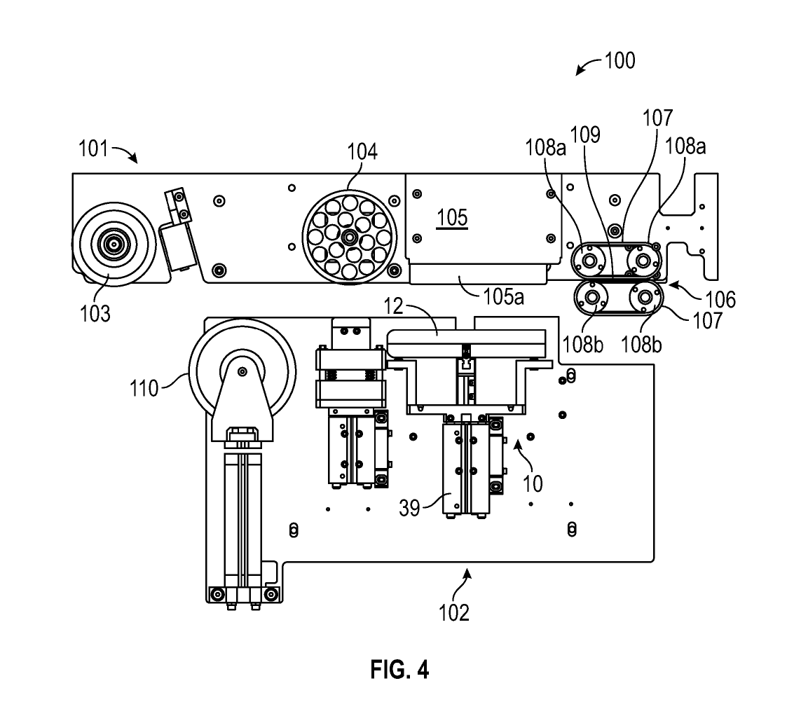

FIG. 4 is a schematic illustration of a marking device according to an embodiment of the present invention.

Referring to FIGS. 1 and 2 of the drawings there is illustrated a stabilising assembly 10 according to an embodiment of the present invention for reducing vibrations and thus stabilising an elongate member (not shown), so that an external surface of the member can be accurately marked or printed with suitable indicia. For the purposes of illustration, the following description is based on the use of the stabilising assembly for stabilising wires, such as electrical wires, during a marking thereof, but it is to be appreciated that the stabilising assembly may also be used to stabilise other elongate members, including the elongate members from the non-exhaustive list comprising electrical cables, tubing, such as heat shrinkable tubing, and optical fibre cables.

The assembly 10 comprises a stabiliser 10a having first and second jaw 11, 12 (as illustrated in FIG. 3 of the drawings) which cooperate to stabilise lateral movement of a wire as the wire is passed therebetween. The first and second jaw 11, 12 may be formed of a metal or rigid plastics material for example, and comprise a first and second planar portion 13, 14 respectively, disposed on a first side 11a, 12a thereof and which are orientated in a face-to-face relation, substantially parallel to each other. The first and second planar portions 13, 14 form an inner side of the stabiliser 10a and define a linear channel 15 therebetween. The jaws 11, 12 are moveable relative to each other such that the width of the channel 15 can be varied to suit the particular wire diameter. In this respect, one jaw may be fixed and the other may be arranged to move relative to the fixed jaw, or both jaws may be moveable relative to each other.

In order to maintain the parallel orientation of the planar portions 13, 14 as the channel width is varied, the assembly 10 further comprises a guide arrangement 16. The guide arrangement 16 comprises a first and second bracket or key 17, 18 which are secured to a respective jaw 11, 12 by passing bolts 19 through apertures 20 formed in each key 17, 18 into internally threaded bores 21 disposed at a central region of each jaw 11, 12, at a second side 11b, 12b thereof (namely an outer side of the stabiliser 10a). A portion of each key 17, 18 is arranged to extend away (downwardly in use) from the respective jaw 11, 12 and comprises a cross-sectional shape which complements a cross-sectional profile of a linear channel or keyway 23 formed within a mounting block 24. The keys 17, 18 are permitted to slide along the keyway 23, and the complementary shaped key 17, 18 and keyway 23 preserve a relative orientation of the jaws 11, 12 as a separation of the jaws is varied. The keys 17, 18 may be arranged to pass along a common keyway 23, or in an alternative embodiment which is not illustrated, the keys 17, 18 may be arranged to pass in separate, parallel orientated keyways.

The positioning of the keys 17, 18 within the keyway 23 and thus the separation of the jaws 11, 12 is controlled by an actuator 25 which in the illustrated embodiment is located at the underside of the mounting block 24, upon a frame 26. The frame comprises two support arms 26a, 26b which extend to the underside of each jaw 11, 12 at a proximal and distal region thereof. Each support arm 26 comprises a first and second stabilising support 27, 28 which are arranged to support a proximal end and distal end of the first and second jaw 11, 12. The stabilising supports 27, 28 comprise an externally threaded portion (not shown) having a roller bearing 29 disposed at one end thereof and the stabilising supports 27, 28 are arranged to screw into internally threaded apertures (not shown) formed in each support arm 26a, 26b such that the roller bearing 29 can contact the underside of the jaws 11, 12. In this respect, the first stabilising supports 27 are arranged to support the proximal and distal region of the first jaw 11 as the first jaw 11 is moved relative to the second jaw 12, and similarly, the second stabilising supports 28 are arranged to support the proximal and distal region of the second jaw 12 as the second jaw 12 is moved relative to the first jaw 11. In an embodiment which is not illustrated, the roller bearings 29 may be arranged to locate within a transverse track or recess (not shown) formed within the underside of each jaw at the proximal and distal region thereof, such that the roller bearing 29 can move back and forth along the respective track as the channel width is varied.

The stabiliser 10a further comprises an entrance 30 disposed at an upstream end of the channel 15, which is defined between cooperating proximal end faces 31, 32 of the first and second jaws 11, 12, and an exit 33 disposed at a downstream end of the channel 15, which is defined between cooperating distal end faces 34, 35 of the first and second jaws 11, 12. The proximal end faces 31, 32 separately comprise a curved surface that extends around an axis orientated substantially transverse to an axis along which the wire extends in passing along the channel, such that the proximal end face of each jaw 11, 12 extends from an inner side to an outer side of the stabiliser 10a. The proximal end face 31, 32 of each jaw 11, 12 forms a continuous surface with the respective planar portion 13, 14 and thus presents a smoothly varying surface for facilitating the transition of a wire from the entrance 30 into the channel 15. The proximal end faces 31, 32 of the jaws 11, 12 diverge away from the upstream end of the channel 15 to create an entrance 30 which tapers inwardly toward the channel 15 and thus facilitates the passage of the wire (not shown) into the channel 15.

Similarly, the distal end face 34, 35 of each jaw 11, 12 comprise a curved surface that extends around an axis orientated substantially transverse to an axis along which the wire extends in passing along the channel, such that the distal end faces 34, 35 extend from an inner side to an outer side of the stabiliser. The distal end face 34, 35 of each jaw 11, 12 similarly forms a continuous surface with the respective planar portion 13, 14 and thus presents a smoothly varying surface for facilitating the transition of a wire from the channel 15 to the exit 33.

The stabiliser 10a further comprises a longitudinally extending opening 36, which in use typically comprises an upper region of the stabiliser 10a, and is formed between a longitudinally extending planar, side face 37, 38 of each jaw 11, 12. The planar faces 37, 38 separately extend from the inner side to an outer side of the stabiliser 10a, along the length of the channel 15, and diverge away from the channel 15 (which in use is typically in an upward direction), such that the longitudinal opening 36 forms a tapered opening so that the wire can easily locate within the channel 15.

Referring to FIG. 4 of the drawings, there is provided a schematic illustration of a wire marking device 100 for marking a wire (not shown) with indicia at preset locations along the length of the wire. In the illustrated embodiment, the wire to be marked is passed into the device 100 from an upstream end (namely, the left hand side when viewed in FIG. 4), between an upper and lower support stage 101, 102.

The upper stage 101 is used to support a plurality of guide wheels 103, 104 (only two of which are illustrated in FIG. 4) for guiding the wire through the device 100, a printing device 105 which may comprise a laser or ink-jet print head 105a for example, for applying the indicia to the wire and drive means 106 disposed at a downstream end of the device 100 for driving (i.e. pulling) the wire through the device 100. The drive means 106 may comprise a drive wheel (not shown) or, as illustrated in FIG. 4, a track arrangement which comprises a pair of tracks 107 which separately extend along a first and second linear arrangement of rollers 108a, 108b. The tracks 107 are disposed one above the other and arranged such that the tracks 107 contact each other along at least a portion of their length to define a pinch region 109 which is used to grip the wire (not shown). The wire is fed between the tracks 107 and thus the pinch region 109 so that the track arrangement 106 can act to pull the wire through the device at a predefined speed, as determined by the speed of tracks.

The lower stage 102 is used to support a further guide wheel 110 which is disposed at a lateral position across the device 100 which is vertically below a region between the upper guide wheels 103, 104, and a stabilising assembly 10 as described above, which is disposed vertically below the print head 105a.

In use, the wire is positioned between the upper and lower stages 101, 102 and fed through the tracks 107 of the track arrangement 106, and then the upper and lower stages 101, 102 are brought together so that the wire contacts a lower region of the upper guide wheels 103, 104 and an upper region of the lower guide wheel 110 and extends into the channel 15 of the stabilising assembly 10 via the longitudinal opening. When the upper and lower stages 101, 102 have been brought together the upper and lower guide wheels 103, 103, 110 act to tension the wire and guide the wire through the channel 115, so that the wire extends in free space along a substantially linear path, between the first and second jaws 11, 12. If required, the vertical positioning of the jaws 11, 12 can be varied through the use of a translation mount 39 to which the frame 26 supporting the stabiliser 10a is coupled.

The separation of the jaws 11, 12 is subsequently reduced using the actuator 25 until the first and second jaw 11, 12, and particularly the first and second planar portions 13, 14 contact opposite sides of the wire with approximately 2 bar of pressure. In this respect, the assembly 10 further comprises a sensor (not shown) for sensing the pressure applied between the jaws 11, 12 and the sensor (not shown) is arranged to output a signal to a controller (not shown) for controlling the operation of the actuator 25. The jaws 11, 12 act to constrain lateral movement of the wire within the channel 15 as the wire is pulled along the channel 15 by the track arrangement 106. The reduced lateral movement thus provides for an improved application of indicia on the external surface of the wire via the print head 105a compared to situations where the wire is arranged to simply pass in free space, or otherwise over a surface, under a printing device.

1. A stabilising assembly for stabilising elongate members during a marking thereof, the assembly comprising a stabiliser comprising a first jaw having at least a first planar portion and a second jaw having at least a second planar portion, the first planar portion being positioned adjacent the second planar portion and arranged in a face-to-face relation therewith, the first and second planar portions being orientated in a substantially parallel orientation to define a linear channel therebetween along which a member is arranged to pass for marking.

2. A stabilising assembly according to claim 1, wherein at least one of the first or second jaws is moveable relative to the second or first jaw respectively, to vary a separation of the first and second planar portions.

3. A stabilising assembly according to claim 2, further comprising at least one actuator for moving at least one of the first or second jaws for varying a separation of the jaws.

4. A stabilising assembly according to claim 2, further comprising a guide arrangement for maintaining the relative orientation of the first and second jaws as the separation of the jaws is varied.

5. A stabilising assembly according to claim 4, wherein the guide arrangement comprises a first and second key which are coupled to a respective jaw.

6. A stabilising assembly according to claim 5, wherein the guide arrangement further comprises a keyway and at least a portion of the first and second keys are arranged to slide within the keyway.

7. A stabilising assembly according to claim 5, wherein the first and second keys are coupled to a central portion of the first and second jaw thereof, respectively.

8. A stabilising assembly according to claim 4, wherein the guide arrangement comprises or further comprises stabilising supports for supporting the jaws at each end thereof.

9. A stabilising assembly according to claim 1, wherein the stabiliser further comprises an entrance disposed at an upstream end of the channel for receiving a member into the channel and an exit disposed at a downstream end of the channel, via which the member exits the channel.

10. A stabilising assembly according to claim 9, wherein the entrance is defined between the proximal end faces of the jaws.

11. A stabilising assembly according to claim 10 wherein the proximal end faces of the jaws diverge away from the upstream end of the channel to create an entrance which tapers inwardly toward the channel and thus facilitates the passage of the member into the channel.

12. A stabilising assembly according to claim 11, wherein each proximal end face comprises a curved surface that extends around an axis orientated substantially transverse to an axis along which the member extends in passing along the channel.

13. A stabilising assembly according to claim 9, wherein the exit is defined between distal end faces of the jaws.

14. A stabilising assembly according to claim 13, wherein the distal end faces of the jaws diverge away from the downstream end of the channel to create an exit which minimises any snagging of the member as it exits the channel.

15. A stabilising assembly according to claim 14, wherein the distal end faces of the jaws separately comprise a curved surface that extends around an axis orientated substantially transverse to an axis along which the member extends in passing along the channel,.

16. A stabilising assembly according to claim 12, wherein the proximal end face of the first and second jaw separately comprise a radius of curvature which are substantially the same.

17. A stabilising assembly according to claim 15, wherein the distal end face of the first and second jaw separately comprise a radius of curvature which are substantially the same.

18. (canceled)

19. A stabilising assembly according to claim 1, wherein the stabiliser comprises a longitudinal opening which extends along the length of the stabilizer.

20. A stabilising assembly according to claim 19, wherein the longitudinal opening is defined between longitudinal side faces of each jaw and wherein the longitudinal side face of each jaw comprises a planar face which extends from an inner side of the stabiliser to an outer side of the stabiliser, along a length of the channel.

21. (canceled)

22. A stabilising assembly according to claim 20, wherein the longitudinal side face of each jaw diverge with respect to each other, in a direction which is away from the channel.

23. (canceled)

24. A marking device for marking elongate members, the device comprising guide means, drive means and a stabilising assembly according to any preceding claim, the guide means being arranged to guide an elongate member through the channel of the stabiliser as the member is driven along the channel by the drive means, the marking device further comprising a printing device for marking the member within the channel as the member passes along the channel.

25. A marking device according to claim 24, wherein the printing device comprises a laser printing device.

26. (canceled)

27. (canceled)

28. (canceled)

29. (canceled)
